(19) United States
(12) Patent Application Publication
(10) Pub. No.: US 2010/0010729 A1
(43) Pub. Date: Jan. 14, 2010

(54) Changing An Operation Of An Engine Associated With A Transportation Device Based On A State Of A Traffic Light

(76) Inventor: Gregory George Hutchinson, Fort Lauderdale, FL (US)

Correspondence Address: Gregory George Hutchinson;Apt. 6, 1250 Miami Rd., Fort Lauderdale, FL, 33316, US

(21) Appl. No.: 12/168,933

(22) Filed: Jul. 8, 2008

(51) Int. Cl. G08G 1/09

(52) U.S. Cl. 701/117

(57) ABSTRACT

Systems and methods to change an operation of an engine associated with a transportation device based on a state of a traffic light are disclosed. A first message is received at a receiver associated with a transportation device from a transmitter associated with a traffic light. A second message is sent based at least partially on the first message to an electronic control unit managing an engine of the transportation device. The second message causes the electronic control unit to stop an operation of the engine.

### I. FIELD

The present disclosure is generally related to changing an operation of an engine associated with a transportation device based on a state of a traffic light.

### II. BACKGROUND

Transportation devices, such as automobiles, motorcycles, trucks, sport utility vehicles (SUVs), and buses, are typically powered by an engine that consumes fuel. The fuel used by the transportation devices may include gasoline, ethanol, and diesel. When a transportation device is stopped at a traffic light while the traffic light goes through a light cycle, the engine of the transportation device is usually consuming fuel even though the transportation device is stationary for a length of time.

Consuming fuel when a transportation device is stationary is wasteful for several reasons. First, during the process of converting the fuel to energy, the engine may emit pollutants into the atmosphere. Second, as fuel costs continue to rise, expensive fuels are needlessly consumed. Third, when the fuel is a fossil fuel like gasoline, scarce natural resources are expended. Thus, consuming fuel when a transportation device is stationary pollutes the environment, is expensive, and expends previous natural resources.

### III. BRIEF SUMMARY

A system and method to receive a first message at a receiver associated with a transportation device from a transmitter associated with a traffic light. A second message is sent based at least partially on the first message to an electronic control unit managing an engine of the transportation device. The second message causes the electronic control unit to stop an operation of the engine.

### IV. BRIEF DESCRIPTION OF THE DRAWINGS

FIG. 1 is a block diagram of a first illustrative embodiment of a system to change a state of an engine associated with a transportation device based on a state of a traffic light;

FIG. 2 is a block diagram of a second illustrative embodiment of a system to change a state of an engine associated with a transportation device based on a state of a traffic light;

FIG. 3 is a flow diagram of a first illustrative embodiment of a method to change a state of an engine associated with a transportation device based on a state of a traffic light; and

FIG. 4 is a flow diagram of a second illustrative embodiment of a method to change a state of an engine associated with a transportation device based on a state of a traffic light.

### V. DETAILED DESCRIPTION

In a particular embodiment, a method includes receiving a first message at a receiver associated with a transportation device from a transmitter associated with a traffic light. The method also includes sending a second message based at least partially on the first message to an electronic control unit managing an engine of the transportation device, the second message causing the electronic control unit to stop an operation of the engine.

In another embodiment, a method includes determining, at a transmitter associated with a traffic light, that the traffic light indicates a stop signal. The method also includes transmitting a first message to a receiver associated with a transportation device to determine an efficiency of stopping an operation of an engine associated with the transportation device.

In another embodiment, a system includes a transmitter coupled to a transmitting antenna and coupled to a traffic light. The transmitter includes a transmit module including computer executable code that when executed by a transmitter processor causes the transmitter processor to determine a first state of the traffic light and to send, via the transmitter, a first message based on the first state of the traffic light. The first message causes an engine associated with a transportation device to change from a first state to a second state.

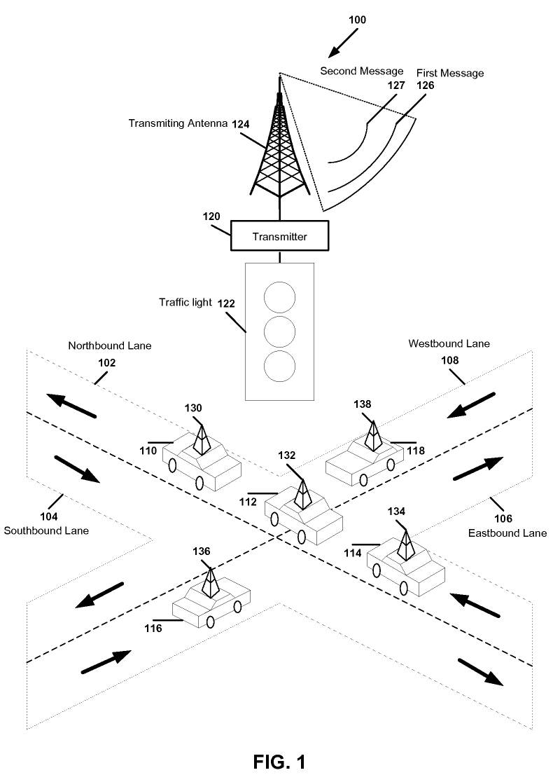

FIG. 1 is a block diagram of a first particular embodiment of a system 100 to change a state of an engine associated with a transportation device based on a state of a traffic light. FIG. 1 illustrates how the system 100 may be deployed at a traffic intersection. The system 100 includes a northbound lane 102, a southbound lane 104, an eastbound lane 106, and a westbound lane 108. Travelling via the northbound lane 102 is a first transportation device 110, a second transportation device 112, and a third transportation device 114. Travelling via the eastbound lane 116 is a fourth transportation device 116. Travelling via the westbound lane 108 is a fifth transportation device 118. The transportation devices 110-118 may be an automobile, a truck, a sport utility vehicle, a bus, a motorcycle, a hybrid-powered vehicle, or other transportation device that consumes fuel. The transportation devices 110-118 may consume a fuel such as gasoline, ethanol, diesel, alcohol, bio-diesel, other transportation fuel, or any combination thereof.

The system 100 includes a transmitter 120 coupled to a traffic light 122 and coupled to a transmitting antenna 124. The transmitting antenna 124 is capable of transmitting one or messages 126 to the transportation devices 110-118.

The transportation device 110 includes an engine (not shown) and a receiver 130. The transportation device 112 includes an engine (not shown) and a receiver 132. The transportation device 114 includes an engine (not shown) and a receiver 134. The transportation device 116 includes an engine (not shown) and a receiver 136. The transportation device 118 includes an engine (not shown) and a receiver 138.

In FIG. 1, traffic light 122 displays a green light to the northbound lane 102 and to the southbound lane 104 enabling transportation devices 110, 112, and 114 to proceed on northbound lane 102. In addition, traffic light 122 displays a red light to the eastbound lane 106 and the westbound lane 108, causing transportation devices 116 and 118 to be stationary. While stationary, the operation of at least one engine of the transportation devices 116 and 118 may be changed by the message 126 via a broadcast by the transmitter 120. For example, the operation of at least one engine of the transportation devices 116 and 118 may be changed from an active state to an inactive state or from an inactive state to an active state.

In an illustrative embodiment, when the traffic light 122 displays a red signal to the eastbound lane 106 and the westbound lane 108, the transmitter 120 sends a first message 126 to the receivers 136 and 138, causing the engines of the transportation devices 116 and 118 to be changed from an active state to an inactive state. For example, the engines of the transportation devices 116 and 188 may change from idle to off. In one embodiment, the first message 126 includes information identifying when the traffic light 122 will transition from the red signal to a green signal. In an alternate embodiment, the transmitter 120 determines when the traffic light 122 will transition from the red signal to a green signal for the lanes 106 and 108, and then sends the message 126 to the receivers 136 and 138, causing the engines of the transportation devices 116 and 118 to be changed from an inactive state to an active state. For example, the engines of the transportation devices 116 and 188 may change from off to idle. The transmitter 120 determines when the traffic light 122 will transition from the red signal to the green signal and sends the second message 127 before the traffic light 122 transitions to the green signal such that when the traffic light 122 transitions to the green signal, the engines transportation devices 116 and 118 have an active state.

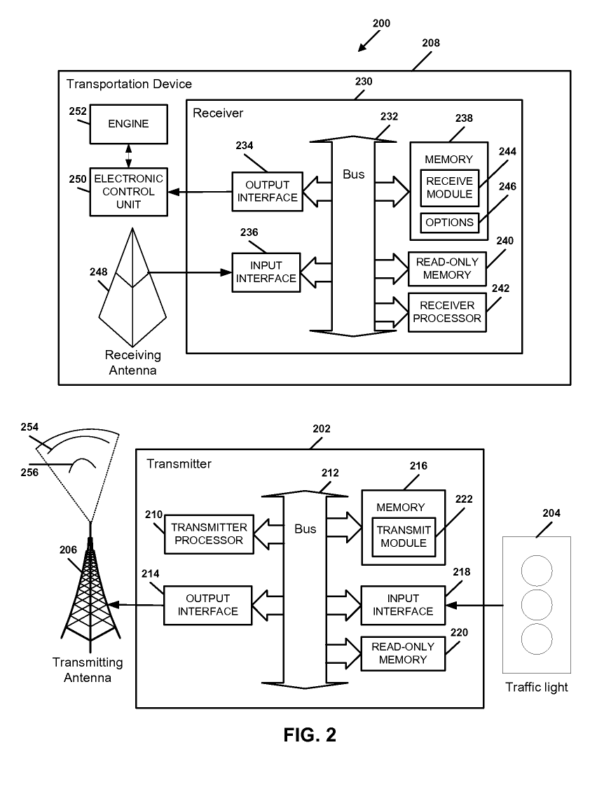

FIG. 2 is a block diagram of a second particular embodiment of a system 200 to change a state of an engine associated with a transportation device based on a state of a traffic light. The system 200 includes a transmitter 202, a traffic light 204, a transmitting antenna 206, and a transportation device 208.

The transmitter 202 includes a transmitter processor 210 coupled to a bus 212. The bus 212 is also coupled at an output interface 214, a memory 216, an input interface 218, and a read-only memory 220. The output interface 214 is coupled to the transmitting antenna 206. The input interface 218 is coupled to the traffic light 204. The memory 216 includes a transmit module 222. The transmit module 222 and the read-only memory 220 may include computer executable code, that when executed by the transmitter processor 210, cause the transmitter processor 210 to perform the various functions of the transmitter 202.

The transportation device 208 includes a receiver 230, a receiving antenna 248, an electronic control unit (ECU) 250, and an engine 252. The receiver 230 includes a bus 232 coupled to an output interface 234. The output interface 234 is also coupled to the ECU 250. The bus 232 is also coupled to an input interface 236. The input interface 236 is further coupled to the receiving antenna 248. The bus 232 is further coupled to a memory 238, a read-only memory 240, and a receiver processor 242. The memory 238 includes a receive module 244 and user-specified options 246. The receive module 244 and the read-only memory 240 may include computer executable code, that when executed by the receiver processor 242, cause the receiver processor 242 to perform the various functions of the receiver 230.

The transmitter 202 associated with the traffic light 204 is operable to determine that the traffic light 204 indicates a stop signal. The transmitter 202 is further operable to send a first message 254 to the receiver 230 associated with the transportation device 208 to determine an efficiency of stopping an operation of an engine associated with the transportation device.

The transportation device 208 is operable to receive a first message 254 at the receiver 230 associated with the transportation device 208 from the transmitter 202 associated with the traffic light 204. Based at least partially on the first message 254, a second message, is sent via the output interface 234 to the ECU 250 managing the engine 252 of the transportation device 208. The second message causes the ECU 250 to stop an operation of the engine 252. Before sending the second message to the ECU 250, an efficiency of stopping the operation of the engine 246 may be determined. In an illustrative embodiment, the second message is sent to the ECU 250 based at least partially on the efficiency of stopping the operation of the engine. For example, when the efficiency of stopping the operation of the engine 246 is below a threshold the second message may not be sent. receiving the first message at the receiver associated with the transportation device;

In an illustrative embodiment, the user-specified options 246 are determined before sending the second message to the ECU 250. The user-specified options 246 may include information on which actions to perform when a message is received via the receiving antenna 248. For example, the user-specified options 246 may indicate that when the ambient temperature is above a threshold, the engine 252 is not sent the second message. For example, the user-specified options 246 may indicate that when the ambient temperature is greater than 85° Fahrenheit, the ECU 250 is not sent a message to stop the operation of the engine 252, enabling the air condition of the transportation device 208 to remain in operation. Similarly, the user-specified options 246 may indicate that when the ambient temperature is less than 85° Fahrenheit, the ECU 250 is sent a message to stop the operation of the engine 252. In an illustrative embodiment, the second message is sent to the ECU 250 based at least partially on the user-specified options 246.

The transmitter associated with the traffic light is operable to determine that the traffic light is transitioning from the stop signal to a start signal and operable to transmit a third message 256 to the receiver 230 associated with the transportation device 208 to start the operation of the engine 252 associated with the transportation device 208.

In one embodiment, a third message 256 is sent from the transmitter 202 associated with the traffic light 204. A fourth message (not shown) is sent to the ECU to start the operation of the engine after receiving the third message 256. Thus, the first message 254 causes the operation of the engine 352 to stop when the traffic light turns red and the second message 256 causes the operation of the engine 352 to start before the traffic light turns green.

In an alternate embodiment, the receiver processor 242 determines a time interval based on the first message 254 and sends a fifth message (not shown) based at least partially on the time interval. The fifth message is sent to the ECU 250 to start the operation of the engine 252. Thus, the first message 254 causes the operation of the engine 352 to stop when the traffic light turns red and the first message 254 specifies a time interval after which the receiver processor 242 causes the operation of the engine 352 to start before the traffic light turns green.

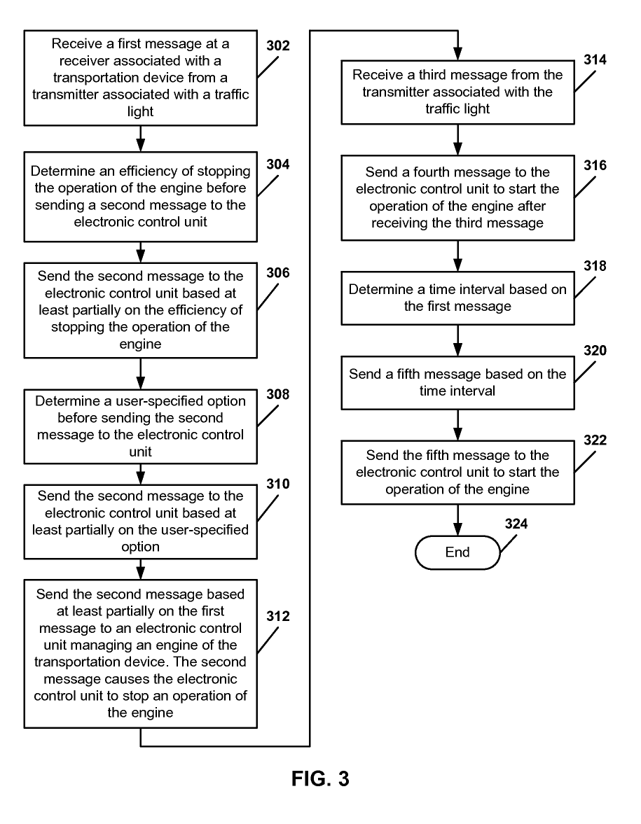

FIG. 3 is a flow diagram of a first illustrative embodiment of a method to change a state of an engine associated with a transportation device based on a state of a traffic light. The method may be performed by the receive module 244 of FIG. 2.

At 302, a first message at a receiver associated with a transportation device from a transmitter associated with a traffic light. At 304, an efficiency of stopping the operation of the engine may be determined before sending a second message to the electronic control unit. At 306, the second message may be sent to the electronic control unit based at least partially on the efficiency of stopping the operation of the engine. At 308, a user-specified option may be determined before sending the second message to the electronic control unit. At 310, the second message may be sent to the electronic control unit based at least partially on the user-specified option.

At 312, based at least partially on the first message, the second message is sent to an electronic control unit managing an engine of the transportation device. The second message causes the electronic control unit to stop an operation of the engine. At 314, a third message may be received from the transmitter associated with the traffic light. At 316, a fourth message may be sent to the electronic control unit to start the operation of the engine after receiving the third message. At 318, a time interval based on the first message may be determined. At 320, a fifth message may be sent based at least partially on the time interval. At 322, the fifth message may be sent to the electronic control unit to start the operation of the engine. The method ends at 324.

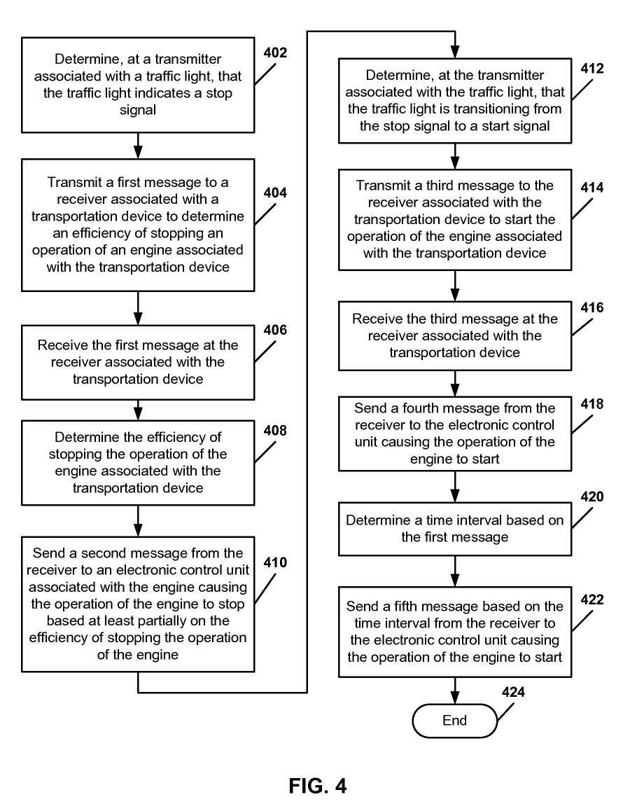

FIG. 4 is a flow diagram of a second illustrative embodiment of a method to change a state of an engine associated with a transportation device based on a state of a traffic light. The method of FIG. 4 may be performed by the transmit module 222 of FIG. 2.

At 402, a determination is made at a transmitter associated with a traffic light that the traffic light indicates a stop signal. At 404, a first message is transmitted to a receiver associated with a transportation device to determine an efficiency of stopping an operation of an engine associated with the transportation device. At 406, the first message is received at the receiver associated with the transportation device. At 408, the efficiency of stopping the operation of the engine associated with the transportation device is determined. At 410, a second message is sent from the receiver to an electronic control unit associated with the engine causing the operation of the engine to stop based at least partially on the efficiency of stopping the operation of the engine.

At 412, at the transmitter associated with the traffic light, a determination is made that the traffic light is transitioning from the stop signal to a start signal. At 414, a third message is transmitted to the receiver associated with the transportation device to start the operation of the engine associated with the transportation device. At 416, the third message is received at the receiver associated with the transportation device. At 418, a fourth message is sent from the receiver to the electronic control unit causing the operation of the engine to start. At 420, a time interval is determined based on the first message. At 422, a fifth message is sent based at least partially on the time interval from the receiver to the electronic control unit causing the operation of the engine to start. The method ends at 424.

Further, embodiments of the present disclosure, such as the one or more embodiments in FIGS. 1-4, can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the data processing system either directly or through intervening I/O controllers.

Network adapters may also be coupled to the data processing system to enable the data processing system to become coupled to other data processing systems or remote printers or storage devices through intervening private or public networks. Modems, cable modems, and Ethernet cards are just a few of the currently available types of network adapters.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

1. A method comprising:
receiving a first message at a receiver associated with a transportation device from a transmitter associated with a traffic light; and
sending a second message based at least partially on the first message to an electronic control unit managing an engine of the transportation device, the second message causing the electronic control unit to stop an operation of the engine.

2. The method of claim 1, further comprising determining an efficiency of stopping the operation of the engine before sending the second message to the electronic control unit.

3. The method of claim 2, further comprising sending the second message to the electronic control unit based at least partially on the efficiency of stopping the operation of the engine.

4. The method of claim 1, further comprising determining a user-specified option before sending the second message to the electronic control unit.

5. The method of claim 4, further comprising sending the second message to the electronic control unit based at least partially on the user-specified option.

6. The method of claim 1, further comprising receiving a third message from the transmitter associated with the traffic light.

7. The method of claim 6, further comprising sending a fourth message to the electronic control unit to start the operation of the engine after receiving the third message.

8. The method of claim 1, further comprising sending a fifth message to the electronic control unit to start the operation of the engine.

9. The method of claim 8, further comprising:
determining a time interval based on the first message; and
sending the fifth message based at least partially on the time interval.

10. A method comprising:
determining, at a transmitter associated with a traffic light, that the traffic light indicates a stop signal; and
transmitting a first message to a receiver associated with a transportation device to determine an efficiency of stopping an operation of an engine associated with the transportation device.

11. The method of claim 10, further comprising:
receiving the first message at the receiver associated with the transportation device;
determining the efficiency of stopping the operation of the engine associated with the transportation device; and
sending a second message from the receiver to an electronic control unit associated with the engine causing the operation of the engine to stop based at least partially on the efficiency of stopping the operation of the engine.

12. The method of claim 11, further comprising:
determining, at the transmitter associated with the traffic light, that the traffic light is transitioning from the stop signal to a start signal; and
transmitting a third message to the receiver associated with the transportation device to start the operation of the engine associated with the transportation device.

13. The method of claim 12, further comprising:
receiving the third message at the receiver associated with the transportation device; and
sending a fourth message from the receiver to the electronic control unit causing the operation of the engine to start.

14. The method of claim 11, further comprising:
determining a time interval based on the first message; and
sending a fifth message based at least partially on the time interval from the receiver to the electronic control unit causing the operation of the engine to start.

15. A system comprising:
a transmitter coupled to a transmitting antenna and coupled to a traffic light, the transmitter including a transmit module including computer executable code that when executed by a transmitter processor causes the transmitter processor to determine a first state of the traffic light and to send, via the transmitter, a first message based on the first state of the traffic light, the first message causing an engine associated with a transportation device to change from a first state to a second state.

15. The system of claim 15, further comprising:
a receiver coupled to a receiving antenna and coupled to an electronic control unit associated with the transportation device, the receiver including a receive module including computer executable code that when executed by a receiver processor causes the receiver processor to receive the first message and to send a second message to an electronic control unit associated with an engine of the transportation device coupled to the electronic control unit, the second message causing the engine to change from the first state to the second state.

17. The system of claim 15, wherein the transmitter is further adapted to determine that the traffic light will transition from the first state to a second state after a time interval.

18. The system of claim 17, wherein the first message includes the time interval and wherein the receiver is further adapted to, based at least partially on a time interval, send a third message to the electronic control unit to the engine of the transportation device, the third message causing the engine to change from the second state to a third state.

19. The system of claim 16, wherein the transmitter is further adapted to send a fourth message to the receiver based at least partially on the time interval.

20. The system of claim 19, wherein the receiver is further adapted to receive the fourth message and to send a fifth message to the electronic control unit to the engine of the transportation device, the fifth message causing the engine to change from the second state to a third state.
